(19) United States
(12) Patent Application Publication
(10) Pub. No.: US 2003/0046192 A1
(43) Pub. Date: Mar. 6, 2003

(54) Distribution management system, distribution management method, and program

(75) Inventors: Koji Eguchi, Tokyo (JP); Toshiharu Inui, Tokyo (JP); Kazuhiko Tsuchiya, Tokyo (JP); Takayuki Fujii, Tokyo (JP); Ryoji Shirouzu, Hyogo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 10/078,468

(22) Filed: Feb. 21, 2002

(30) Foreign Application Priority Data
Aug. 29, 2001 (JP) 2001-259698

(51) Int. Cl. G06F 17/60

(52) U.S. Cl. 705/28

(57) ABSTRACT

A distribution management system in which a host server and portable terminals are arranged in such a manner as to be able to exchange information with each other. The host server has a section for receiving information relating to distribution from each of the portable terminals, and a section for transmitting, to each of the portable terminals, predetermined information such as information indicating a distribution state or history of a distribution article. This makes it possible to transmit, in real time, predetermined information such as information indicating a distribution state or history of a distribution article from the host server to a transmission source portable terminal.

### BACKGROUND OF THE INVENTION

1. Field of the Invention

The present invention relates to a distribution management system, a distribution management method, a program, and a recording medium. In particular, the invention is suitably applied to distribution management of a production line of a factory or the like, at least part of the distribution management being done manually.

2. Background Art

In conventional distribution management, in a distribution management subject site such as a factory, client terminals are installed at necessary locations and connected to a host server via a LAN (local area network). Information is exchanged between the host server and the client terminals.

FIG. 3 is a schematic diagram showing a conventional distribution management method. A plurality of PC terminals 102 as client terminals are connected to a host server 101 via a LAN 105. Products as distribution articles are input lot by lot (denoted by reference numeral 104) to various apparatuses 103 installed in a factory such as manufacturing apparatuses and test apparatuses.

However, the conventional distribution management method of FIG. 3 has a problem of low flexibility because the host server 101 performs necessary processing by receiving information from the PC terminals 102 which are wired terminals. More specifically, in a manual management production line, installing the PC terminals 102 adjacent to the respective apparatuses 103 is difficult in a physical sense and inefficient in terms of the cost. Therefore, in a factory, a necessary number of PC terminals 102 are installed one for each area that is large to some extent. This results in a problem that a PC terminal 102 for information input/output may be too distant from apparatuses 103 that perform actual operations.

Because of the above situation, for example, a method is employed that an operator copies information on operation start conditions indicating what products should be processed by what apparatuses into a memo pad or the like by referring to the PC terminal 102 and he goes to an apparatus 103 and inputs the copied information to the apparatus 103. Particularly in a manual line, an operator cannot directly recognize and input latest information.

After completion of processing, in the case where there exist various kinds of measurement information and processing data (time, amount, length, etc.) on products obtained by an apparatus 103, information on product abnormality (loss of part of products, loss of all products, occurrence of an abnormality, etc.), or like information, an operator needs to make notes of such information based on the information on the apparatus 103 and inputs it to the PC terminal 102.

Copying errors and input errors tend to occur in such work as information acquisition, notes making, and manual input to the PC terminal 102 and are a factor of lowering the product quality. Further, in replacing old information with latest one, it is necessary to rewrite the instruction document of the line.

On the other hand, Japanese Patent Laid-Open No. 7-212814 discloses an interface apparatus for connection between a wired LAN and radio cell phones. However, this publication only describes a connection apparatus on a LAN that is given a function of a radio base station, and does not describe any means for operating the system.

Japanese Patent Laid-Open No. 11-300585 discloses a technique that work loads are registered on the host side and an operator rearrangement instruction is given through a portable terminal. Japanese Patent Laid-Open No. 2000-226108 discloses a technique that a product delivery destination instruction and information on trucks going to a delivery destination are displayed.

Japanese Patent Laid-Open No. 2000-107994 discloses a method for registering current apparatus statuses in the case where portable terminals are used to provide an equipment management function. This publication also discloses a feature that in operator registration each portable terminal is held by an individual person.

Japanese Patent Laid-Open No. 4-343630 discloses a technique that as for management of expendable supplies an operator can issue a supply request from a terminal.

However, in the methods disclosed by the above publications, information exchange is merely performed by using portable terminals. It is impossible to report information on distribution and obtain necessary information in real time based on the report. In particular, incapability of exchanging such information as product processing conditions and an operation report causes a problem that information necessary for production in a factory cannot be delivered. Therefore, received information is transient in nature and proper information that is suitable for processing conditions in each manufacturing process cannot be obtained. Where each portable terminal is held by an individual person in operator registration, a flexible measure cannot be taken when an operator is absent.

### SUMMARY OF THE INVENTION

The present invention has been made to solve the above problems in the art, and an object of the invention is therefore to efficiently use information that is necessary in a manual production line and to enable reliable information delivery between client terminals and apparatuses in a factory.

According to one aspect of the present invention, there is provided a distribution management system in which a host server for managing distribution and portable terminals are arranged in such a manner as to be able to exchange information with each other. The host server comprises means for receiving information relating to distribution from each of the portable terminals and means for transmitting, to each of the portable terminals, predetermined information that is one of kinds of information including individual information on a distribution article, information relating to a process to be executed on the distribution article, and information relating to an apparatus for processing the distribution article.

According to another aspect of the present invention, a distribution management method comprises the following steps. Firstly a portable terminal acquires information relating to distribution. Secondly the portable terminal transmits the information relating to distribution to a host server. Thirdly the host server transmits, to the portable terminal, predetermined information that is one of kinds of information including individual information on a distribution article, information relating to a process to be executed on the distribution article, and information relating to an apparatus for processing the distribution article. Fourthly the portable terminal display the predetermined information.

According to another aspect of the present invention, there is provided a program for transmitting predetermined information to a portable terminal. The program causes a computer to function as means for receiving information relating to distribution from the portable terminal and means for transmitting, to the portable terminal, predetermined information that is one of kinds of information including individual information on a distribution article, information relating to a process to be executed on the distribution article, and information relating to an apparatus for processing the distribution article.

According to the present invention, receiving information relating to distribution from a portable terminal, the distribution host server can transmit, to the transmission source portable terminal, in real time, predetermined information such as individual information on a distribution article or information relating to a process to be executed on the distribution article.

Other and further objects, features and advantages of the invention will appear more fully from the following description.

### BRIEF DESCRIPTION OF THE DRAWINGS

FIG. 1 is a schematic diagram of a distribution management system according to the embodiment of the invention.

FIG. 2 is a schematic diagram showing the contents of information that is exchanged between the host server and each portable terminal.

FIG. 3 is a schematic diagram showing a conventional distribution management method.

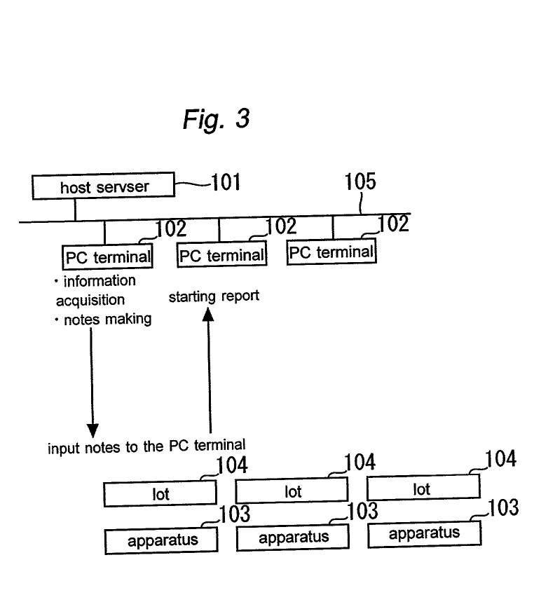

### DETAILED DESCRIPTION OF THE PREFERRED EMBODIMENTS

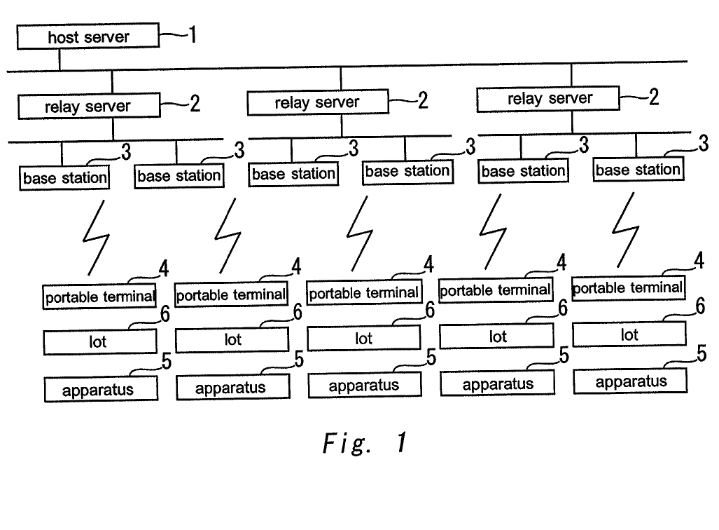

A specific embodiment of the present invention will be hereinafter described with reference to the accompanying drawings. FIG. 1 is a schematic diagram of a distribution management system according to the embodiment of the invention. In this embodiment, the distribution management system is applied to distribution management of products manufactured in a factory.

As shown in FIG. 1, the distribution management system is provided with a host server 1, a plurality of relay servers 2, and a plurality of base stations 3 that are connected to the respective relay servers 2.

Various apparatuses 5 such as product manufacturing apparatuses and test apparatuses are provided in the factory. In the factory, products are managed lot by lot (denoted by reference numeral 6) and products are input to a plurality of apparatuses 5 lot by lot.

A plurality of operators having respective portable terminals 4 are arranged in the factory. Information is exchanged by radio between the portable terminal 4 of each operator and each base station 3. Information received by or transmitted from a base station 3 is supplied to or from the host server 1 via the relay server 2. Information to be sent from each portable terminal 4 to the host server 1 is information relating to distribution such as an inquiry relating to a process to be performed on distribution products, an inquiry relating to the lot of distribution products, information relating to an apparatus for processing distribution products, and information on a part to be used for manufacture of distribution products. On the other hand, information to be sent from the host server 1 to each portable terminal 4 is individual information such as lot information or part information on distribution products, information relating to a process to be executed on distribution products, information relating to an apparatus for processing distribution products, and other information.

Specific examples of information that is transmitted from each portable terminal 4 are menu selection information, user registration information, search subject information, a condition selection result, processing start/completion information, QC data, a search condition, storage location information, stock acceptance/output information, and an apparatus status. Specific examples of information that is received by each portable terminal 4 are operation start conditions (a process name, an apparatus name, a recipe, etc.), a search result, a specification judgment result, transmission information normal reception/confirmation information, and input error information.

Transmission of information from each portable terminal 4 to the host server 1 is performed by a transmitting means of the portable terminal 4, and transmitted information is received by a receiving means of the host server 1. Transmission of information from the host server 1 to each portable terminal 4 is performed by a transmitting means of the host server 1, and transmitted information is received by a receiving means of the portable terminal 4. Information received by each portable terminal 4 is displayed by its display means.

In the distribution management system having the above configuration, an identification tag is attached or stuck to each lot 6. A unique bar code, for example, may be used as an identification tag. An operator reads an identification tag with the portable terminal 4 and transmits read-out information to the host server 1. A bar code is read by a bar code reading means of the portable terminal 4. For example, when an operator wants to obtain information on a lot 6 that has not been processed completely and is located in the vicinity of an apparatus 5, he reads the identification tag attached to the lot 6 with the portable terminal 4 and exchanges information with the host server 1 via a base station 3 and a relay server 2. Instead of reading a bar code with the portable terminal 4, the operator may directly inputs information relating to the lot 6 to the portable terminal 4. Based on information received, the host server 1 exchanges information with the portable terminal 4 for the products of the lot 6 while referring to its own database.

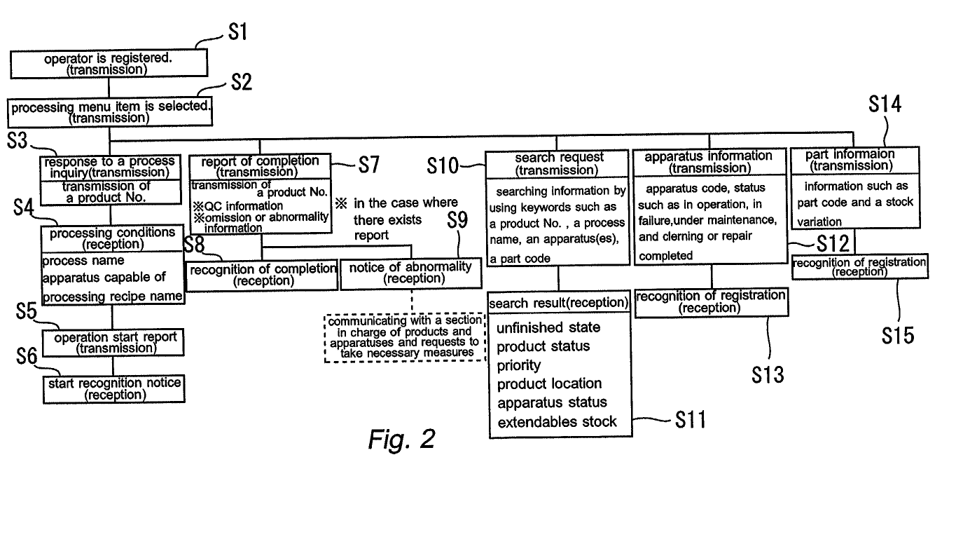

FIG. 2 is a schematic diagram showing the contents of information that is exchanged between the host server 1 and each portable terminal 4. FIG. 2 shows the contents of information to be exchanged as viewed from each portable terminal 4 (transmission side). First, at step S1, an operator is registered through the portable terminal 4 and resulting information is transmitted to the host server 1.

In the operator registration at step S1, the portable terminal 4 is not held by an individual person but can be shared by an unspecified number of persons. A function is provided that if an operator is initially registered in the host server 1, in the next and following operations the same operator who expressed his intention of using the portable terminal 4 is set as a person in charge of operations by default as long as the power is kept on. To enable another person to use the portable terminal 4, it is necessary to turn the power off and perform re-registration or to change the default setting by inputting his operator code. With this measure, while a particular operator works holding the portable terminal 4, his operator code can be stored after it has been registered first time as long as the power is kept on (it is not necessary to register his operator code for every operation). Therefore, the operator's input manipulations can be simplified in using the portable terminal 4 second time or later, and the portable terminal 4 can be shared by an unspecified number of operators.

At step S2 and the following steps, a processing menu item is selected through the portable terminal 4 and transmitted to the host server 1. Information exchange is then performed between the portable terminal 4 and the host server 1. Specific examples of information exchanged are as follows.

(1) In response to a process inquiry (step S3) from the portable terminal 4, the host server 1 transmits processing conditions (step S4).

This processing is performed when the operator inquires by which apparatus 5 the products of a lot 6 should be processed. At step S3, the portable terminal 4 performs, for example, transmission of a product No. to the host server 1. As described above, the product No. is acquired from the identification tag that is attached to the lot 6. At step S4, the portable terminal 4 receives, from the host server 1, processing conditions such as a process name, an apparatus capable of processing, a recipe name, product processing conditions, and display of the next process. The host server 1 transmits such information based on the received product No.

(2) In response to an operation start report (step S5) sent from the portable terminal 4, the host server 1 transmits a start recognition notice to the effect that it has recognized that the lot 6 has been input to the predetermined process (step S6).

At step S5, the portable terminal 4 transmits, to the host server 1, a report to the effect that the lot 6 has been input to a predetermined process. At step S6, the host server 1 recognizes that the lot 6 has been input to the predetermined process and returns a notice to that effect to the portable terminal 4.

(3) In response to a completion report (step S7) sent from the portable terminal 4, the host server 1 transmits a notice to the effect that processing on a lot 6 has completed (step S8).

At step S7, the portable terminal 4 transmits, to the host server 1, a report to the effect that processing on a lot 6 has completed. At step S8, the host server 1 transmits, to the portable terminal 4, a notice to the effect that it has recognized that the processing on the lot 6 has completed. At step S7, in the case where there exists QC information (quality measurement data), the portable terminal 4 transmits a report to the effect that the processing has completed normally if the products of the lot 6 are within quality specifications and transmits an alarm if they are out of the quality specifications. Examples of QC information are such pieces of product information as a processing time, a density, a film thickness, and dimensions. If the products of the lot 6 are within the quality specifications, at step S8 the host server 1 transmits a notice to the effect that it has recognized that the processing on the lot 6 has completed. If the products of the lot 6 are not within the quality specifications, at step S9 the host server 1 transmits a notice to the effect that it has recognized that an abnormality occurred. After execution of step S9, the host server 1 communicates with a section in charge of products and apparatuses and requests it to take necessary measures.

(4) In response to a lot search request (step S10) sent from the portable terminal 4, the host server 1 transmits a lot search result (secondary information) (step S11).

At step S10, the portable terminal 4 transmits the contents of a lot search request to the host server 1. At this time, the portable terminal 4 transmits search information (keyword(s)) such as a product No., a process name, an apparatus(es) that performs processing, and/or a part code. At step S11, the host server 1 transmits a search result. Examples of a search result are such pieces of information as an unfinished state, a product status, priority, a product location, an apparatus status, and an expendables stock.

(5) In response to apparatus information (step S12) sent from the portable terminal 4, the host server 1 transmits a notice to the effect that the apparatus information has been registered (step S13).

At step S12, the portable terminal 4 transmits information on an apparatus 5. At step S13, the host server 1 registers the information relating to the apparatus 5 in the database and transmits a notice to that effect. Examples of apparatus information are an apparatus(es) code, and statuses such as in operation, in failure, under maintenance, and cleaning or repair completed.

Where the portable terminal 4 has a equipment management function, at step S13 the host server 1 not only registers a current state of the apparatus 5 but also transmits, to the portable terminal 4, necessary information such as recovery information for the apparatus 5. For example, when the portable terminal 4 has transmitted at step S12 a report to the effect that the apparatus 5 is abnormal, at step S13 the host server 1 retrieves a failure history of the apparatus 5 and recovery information such as cause/countermeasure information from the information stored in its database and transmits those pieces of information directly to the transmission source portable terminal 4. When the host server 1 searches the database for recovery information, its uses a received failed apparatus code and failure mode as search conditions and transmits, to the portable terminal 4, information with the same or similar failure occurrence conditions. As a result, an operator carrying the portable terminal 4 can view the recovery information at hand in real time paperlessly. Based on the recovery information displayed on the portable terminal 4, the operator can recover the apparatus 5 where the abnormality occurred. If the amount recovery information is unduly large, the host server 1 transmits table-of-contents information and causes it to be displayed on a search terminal (not shown) on the same LAN as the host server 1 is connected to, to thereby allow the operator to receive the recovery information.

(6) In response to part information (step S14) sent from the portable terminal 4, the host server 1 transmits a notice to the effect that the part information has been registered (step S15).

At step S14, the portable terminal 4 transmits part information. Examples of part information are a part code and a stock variation. At step S15, the host server 1 registers the received part information in the database and transmits a notice to that effect.

As for management of members (in particular, expendable parts having usable periods) necessary for manufacture of products, codes, proper stocks, valid periods, and dates of purchase of the respective members are registered in the host server 1 in advance. When the host server 1 judges, based on results of use of a part that are sent from the portable terminal 4 at step S14, that the stock of the part has become smaller than the proper amount registered in the host server 1, the host server 1 can automatically issue an order instruction. The host server 1 (actually a stock managing means) manages the stock information in real time.

Based on results of use and a consumable period of a member, the lower limit value of the stock of the member is set in advance to a value that is determined based on an estimated consumption number of the member during a period to an appointed date of delivery in consideration of a variation number in the results of use (a guideline value is 1.2 times the estimated consumption number). Similarly, the upper limit of the stock is set in advance to a value that is determined based on a result (number) of use during an effective consumable period (e.g., six months itself) in consideration of a variation number (a guideline value is 0.8 times the result of use). The host server 1 automatically performs stock management including ordering so that the stock falls between the upper limit value and the lower limit value. Since the stock is not left to a judgment of an operator, the stock can always be kept at a proper number.

As described above, when an operator works using a portable terminal 4, he can use latest information by directly accessing the host server 1 and receives information therefrom in front of the operation screen of an apparatus 5. Since the portable terminals 4 are used as production management equipment, in response to transmission information the host server 1 returns a notice of normal reception/registration completion to the respective transmission source portable terminal 4.

Where the number of portable terminals 4 used is small, for example, less than 30, the relay servers 2 may play the roles of the host server 1. The relay servers 2 may also play the roles of the host server 1 in the case where the functions of the host server 1 are simple, for example, the host server 1 merely receives transmission information.

As described above, as for exchange of such information as a process inquiry or a lot search, the embodiment enables real-time information to exchange between each portable terminal 4 and the host server 1. Since each operator can perform necessary information input/output work at hand, he need not do double work of copying and input. Since the information management is performed by the host server 1 in real time in a unified manner, information can be managed in real time and operation change instructions can be updated en bloc. Further, the operating means that takes into account the operator interface can prevent operation errors and decreases deterioration in quality.

Since an operator can recognize maintenance recovery information at hand, he can quickly repair an apparatus 5 where an abnormality has occurred, which makes it possible to increase the equipment operation efficiency. Further, by keeping proper stocks of members, that is, by preventing members from becoming out of stock and preventing members from being left after passage of their consumable periods, the amount of bad resources can easily be reduced.

Although in the above description the invention is directed to a production line of a factory or the like, increase in efficiency can be expected by a similar manner of operation in businesses and services (transport distribution etc.) in which a plurality of processes are managed.

As described above, the processing steps of the embodiment can be implemented by the hardware of the host server 1 and the portable terminals 4. Alternatively, the individual function blocks and processing steps may be implemented by a microcomputer system consisting of a CPU or an MPU, a ROM, a RAM, etc. (not shown) of each of the host server 1 and the portable terminals 4 and their operations may be realized according to operation programs stored in the ROM or RAM. Operation programs may be separated from the host server 1 and the portable terminals 4, that is, a recording medium in which such operation programs are stored may be loaded into a loading section that is provided in the host server 1 etc.

The invention covers a system in which software programs for realizing the above individual function blocks are supplied to the RAMs of the host server 1 and the portable terminals 4 and the individual function blocks are caused to operate according to those programs. In this case, the software programs themselves realizes the functions of the embodiment, and hence the programs themselves and means for supplying the programs to a computer such as a recording medium in which the programs are stored are covered by the invention.

Having the features described above, the invention provides the following advantages.

Receiving information relating to distribution from a portable terminal, the distribution host server can transmit, to the transmission source portable terminal, in real time, predetermined information such as individual information on a distribution article or information relating to a process to be executed on the distribution article.

By displaying information transmitted from the distribution host server on a portable terminal, an operator can acquire the information in front of an apparatus for processing a distribution article. This makes it unnecessary for an operator to do double work of copying and input, and hence can prevent quality deterioration due to a human error and can prevent increase of manufacturing steps.

By causing a portable terminal to transmit identification information representing a type of distribution article to the distribution host server, the distribution host server can transmit processing conditions suitable for the type of distribution article to the portable terminal in real time.

Acquiring identification information from a bar code that is attached to a distribution article can prevent input errors due to manual input.

Transmitting information including recovery information for an apparatus to a portable terminal makes it possible to quickly recover the apparatus where an abnormality has occurred and thereby to increase the equipment operation efficiency.

By transmitting, to the distribution host server, information relating to a member to be used for manufacture of a distribution article, the distribution host server can acquire information on the member in real time and hence can take proper measures.

The distribution host server's managing the stocks of members based on information relating to the members can prevent the members from becoming out of stock. Further, bad resources can be reduced by keeping proper member stocks so as to prevent the members from being left after passage of their consumable periods.

Transmitting, to the distribution host server, information relating to a plurality of operators who use the same portable terminal allows an unspecified number of operators to share a portable terminal.

Employing a PHS radio device, an SS radio device, a mobile terminal, a PDA terminal, or a Palm terminal as each of the portable terminals allows an operator to acquire information in front of an apparatus for processing a distribution article, which eliminates double work of copying and input.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-259698, filed on Aug. 29, 2001 including specification, claims, drawings and summary, on which the Convention priority of the present application is based, are incorporated herein by reference in its entirety.

1. A distribution management system in which a host server for managing distribution and portable terminals are arranged in such a manner as to be able to exchange information with each other, wherein said host server comprises:
means for receiving information relating to distribution from each of said portable terminals; and
means for transmitting, to each of said portable terminals, predetermined information that is one of kinds of information including individual information on a distribution article, information relating to a process to be executed on said distribution article, and information relating to an apparatus for processing said distribution article.

2. The distribution management system according to claim 1, wherein each of said portable terminals comprises:
means for acquiring said information relating to distribution;
means for transmitting said information relating to distribution to said host server;
means for receiving said predetermined information from said host server; and
means for displaying said predetermined information.

3. The distribution management system according to claim 2, wherein said information relating to distribution is identification information representing a type of said distribution article.

4. The distribution management system according to claim 3, wherein each of said portable terminals further comprises bar code reading means, and wherein said bar code reading means acquires said identification information from a bar code that is attached to said distribution article.

5. The distribution management system according to claim 1, wherein said information relating to an apparatus for processing said distribution article includes information necessary to recover an apparatus where an abnormality has occurred.

6. The distribution management system according to claim 1, wherein said information relating to distribution is information relating to a member that is used for manufacture of said distribution article.

7. The distribution management system according to claim 6, wherein said host server further comprises means for managing a stock of said member based on said information relating to the member.

8. The distribution management system according to claim 1, wherein said information relating to distribution includes information relating to different operators who use the same portable terminal.

9. A distribution management method comprising the steps of:
a portable terminal's acquiring information relating to distribution;
said portable terminal's transmitting the information relating to distribution to a host server;
said host server's transmitting, to said portable terminal, predetermined information that is one of kinds of information including individual information on a distribution article, information relating to a process to be executed on said distribution article, and information relating to an apparatus for processing said distribution article; and
said portable terminal's displaying said predetermined information.

10. The distribution management method according to claim 9, wherein said information relating to distribution is identification information representing a type of said distribution article.

11. The distribution management method according to claim 9, wherein the acquiring step is said portable terminal's acquiring said identification information from a bar code that is attached to said distribution article.

12. The distribution management method according to claim 9, wherein said information relating to an apparatus for processing said distribution article includes information necessary to recover an apparatus where an abnormality has occurred.

13. The distribution management method according to claim 9, wherein said information relating to distribution is information relating to a member that is used for manufacture of said distribution article.

14. The distribution management method according to claim 13, further comprising the step of said host server's managing a stock of the member based on said information relating to the member.

15. The distribution management method according to claim 9, wherein said information relating to distribution includes information relating to different operators who use the same portable terminal.

16. A program for transmitting predetermined information to a portable terminal, the program causing a computer to function as:
means for receiving information relating to distribution from the portable terminal; and
means for transmitting, to the portable terminal, predetermined information that is one of kinds of information including individual information on a distribution article, information relating to a process to be executed on said distribution article, and information relating to an apparatus for processing said distribution article.

17. The program according to claim 16, wherein the program further includes a program for causing the computer to function as means for receiving identification information representing a type of said distribution article.

18. The program according to claim 16, wherein the program further includes a program for causing the computer to function as means for transmitting information necessary to recover an apparatus where an abnormality has occurred.

19. The program according to claim 16, wherein the program further includes a program for causing the computer to function as means for receiving information relating to a member that is used for manufacture of said distribution article.

20. The program according to claim 19, wherein the program further includes a program for causing the computer to function as means for managing a stock of said member based on said information relating to the member.
